(19) United States
(12) Patent Application Publication
(10) Pub. No.: US 2026/0222347 A1
(43) Pub. Date: Jul. 30, 2026

(54) Network Resiliency in High-Speed Networks

(71) Applicant: Cisco Technology, Inc., San Jose, CA (US)

(72) Inventors: Srinivas Gangam, San Jose, CA (US); Ramesh Sivakolundu, San Jose, CA (US)

(21) Appl. No.: 19/038,357

(22) Filed: Jan. 27, 2025

(51) Int. Cl. H04L 47/122; H04L 5/00; H04L 45/24

(52) U.S. Cl. CPC H04L 47/122; H04L 5/0055; H04L 45/24

(57) ABSTRACT

Devices, systems, methods, and processes for improving network resiliency using congestion notification within a network are described herein. In UEC enabled (or RDMA) networks, when a communication link gets congested, the packets are buffered and eventually dropped within the switches. Typically, the source device needs to rely on retransmit timeout, which may lead to huge latency. Therefore, the present disclosure presents a solution that leverages congestion signaling or packet trimming techniques for congestion or link failure management. When a switch receives a packet associated with a first entropy value and detects that an egress port associated with the first entropy value is unavailable, the switch modifies the packet and forwards the modified packet via a different port associated with a second entropy value to seek an acknowledgment or a negative acknowledgment for the first packet before a source endpoint of the packet times out.

The present disclosure relates to communication networks. More particularly, the present disclosure relates to improving network resiliency during network congestion or link failures in high-speed communication networks.

### BACKGROUND

With the emergence of high-performance computing, such as AI-ML networking, Ultra Ethernet Consortium (UEC) or Remote Direct Memory Access (RDMA) has emerged as a pivotal protocol to facilitate enhanced data throughput, low latency, and scalability. UEC aims at addressing the limitations of Ethernet for ultra-demanding use cases by defining new standards, protocols, and optimizations.

In UEC enabled AI-ML networks, when network links may be down due to failure or congestion, the packets get buffered and may eventually be dropped inside network switches handling the packets. When links are down or congested, rapid fault recovery may help in maintaining efficient operation of the AI-ML networks to avoid bottlenecks and task delays. Thus, an initiator fabric endpoint (FEP) may retransmit the dopped packets upon being triggered by a retransmission timer, for example, when the retransmission timer times out. However, the retransmission timer timeout period may be long, for example, in the order of milliseconds, which may increase latency for retransmitting dropped packets and lead to an increased job completion time.

### SUMMARY OF THE DISCLOSURE

Systems and methods for improving network resiliency during network congestion or link failures in high-speed communication networks in accordance with embodiments of the disclosure are described herein. In many embodiments, a network device, comprising a plurality of ports, a processor, a memory communicatively coupled to the processor, is provided. The memory comprises a congestion management logic that is configured to receive a packet associated with a first entropy value, identify, from the plurality of ports, a first port associated with the first entropy value, detect that the first port is unavailable for transmission, modify the received packet based on the first port being unavailable, and transmit the modified packet via a second port of the plurality of ports.

In a number of embodiments, prior to transmitting the modified packet, the congestion management logic is further configured to select the second port from the plurality of ports. In many embodiments, the second port is different from the first port.

In a variety of embodiments, the second port is associated with a second entropy value different from the first entropy value.

In additional embodiments, the second port corresponds to a backup port for the first entropy value.

In further embodiments, to identify the first port, the congestion management logic is further configured to perform an Equal-Cost Multi-Path (ECMP) route lookup based on the first entropy value.

In still further embodiments, detecting that the first port is unavailable comprises detecting that a communication link associated with the first port is down.

In still more embodiments, detecting that the first port is unavailable comprises detecting that the first port is experiencing congestion.

In still additional embodiments, the received packet includes a payload and is associated with a first priority value.

In yet more embodiments, to modify the packet, the congestion management logic is further configured to trim the payload from the packet, and change the first priority value to a second priority value.

In still yet more embodiments, the congestion management logic is configured to transmit the modified packet to a destination endpoint of the received packet.

In many further embodiments, the congestion management logic is further configured to receive a negative acknowledgment in response to transmitting the modified packet. The negative acknowledgment comprises a reason code assigned for a trimmed packet type and the first entropy value. In many additional embodiments, the congestion management logic is further configured to forward the negative acknowledgment to a source endpoint of the packet, and receive, from the source endpoint, at least one new packet associated with a second entropy value based on the forwarded negative acknowledgment. The second entropy value is different from the first entropy value.

In still yet further embodiments, the new packet corresponds to a retransmitted version of the packet.

In still yet additional embodiments, to modify the packet, the congestion management logic is further configured to mark the packet with a congestion indicator.

In several embodiments, the congestion indicator includes an Explicit Congestion Notification (ECN) mark.

In several more embodiments, the congestion management logic is further configured to receive an acknowledgment in response to transmitting the modified packet. The acknowledgment comprises the congestion indicator. In numerous embodiments, the congestion management logic is configured to forward the acknowledgment to a source endpoint of the packet, and receive, from the source endpoint, at least one new packet associated with a second entropy value based on the forwarded acknowledgment. The second entropy value is different from the first entropy value.

In numerous additional embodiments, the network device comprises a network switch.

In further additional embodiments, a network device, comprising a processor, a memory communicatively coupled to the processor, is provided. The memory comprises a congestion management logic that is configured to transmit a first packet of a traffic flow. The first packet is associated with a first entropy value. The congestion management logic is configured to receive, in response to the transmitted first packet, one of an acknowledgment with a congestion indicator or a negative acknowledgment with a designated reason code, and transmit a second packet of the traffic flow based on receiving one of the acknowledgment or the negative acknowledgment. The second packet is associated with a second entropy value.

In many embodiments, the network device corresponds to an initiator endpoint device.

In additional embodiments, the congestion management logic is further configured to defer a utilization of the first entropy value for at least one round trip time associated with the first entropy value.

In still additional embodiments, a method for congestion management, is provided. The method comprising receiving, by a network device, a packet associated with a first entropy value, identifying, from a plurality of ports of the network device, a first port associated with the first entropy value, detecting that the first port is unavailable for transmission, modifying the received packet based on the first port being unavailable, and transmitting the modified packet via a second port of the plurality of ports.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example architecture for a network fabric in accordance with various embodiments of the disclosure;

FIG. 2 is an example network system for congestion management between a source endpoint device and a target endpoint device in accordance with various embodiments of the disclosure;

FIG. 3 is an example high-speed network system with improved network resiliency in accordance with various embodiments of the disclosure;

FIG. 4 is a flowchart showing a process for improving network resiliency in a high-speed network in accordance with various embodiments of the disclosure;

FIG. 5 is a flowchart showing a process for switch-triggered congestion and link failure management using a congestion indicator in accordance with various embodiments of the disclosure;

FIG. 6 is a flowchart showing a process 600 for switch-triggered link failure management using a forced NACK response in accordance with various embodiments of the disclosure;

FIG. 7 is a flowchart showing a process for congestion management by a source endpoint device in accordance with various embodiments of the disclosure;

FIG. 8 is a flowchart showing a process for congestion management by a source endpoint device in accordance with various embodiments of the disclosure;

FIG. 9 is a flowchart showing a process for link failure management by a source endpoint device in accordance with various embodiments of the disclosure; and

FIG. 10 is a conceptual block diagram for one or more devices capable of executing components and logic for implementing the functionality and embodiments described in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide overlaying an explicit congestion notification (ECN) or packet trimming technique for congestion or link failure management within a network. With the advancements in Artificial Intelligence (AI)/Machine learning (ML) networks, handling large datasets for high-performance computing demands high-speed data transfer, low-latency communication, and robust computation frameworks. To adapt Ethernet technology to the demanding requirements of modern AI/ML networks, Ultra Ethernet Consortium (UEC) has been formed to advance Ethernet-based networking technologies for high-performance applications. AI/ML networks in UEC environments use adaptive congestion control to prioritize and manage time-sensitive data traffic, reducing bottlenecks during peak loads. In UEC-enabled AI/ML networks, packet spraying helps meet the demands of high-performance networks. Packet spraying is a networking technique in which the packets are distributed or “sprayed” across multiple network paths between a source and a destination to optimize performance, reduce congestion, and improve reliability. By sending packets over different paths, packet spraying helps mitigate the impact of link congestion, thus ensuring steady data flow. However, in certain scenarios, such as network congestion or link failure, the packets may get buffered and eventually be dropped by an intermediate network node, such as a switch, router, gateway, or the like. Typically, UEC standard protocol or Remote Direct Memory Access (RDMA) provides a solution that relies on source timeout for packet drops. In such a situation, a source endpoint device may not receive an acknowledgment from a target endpoint device. Thus, the source endpoint device, triggered by a timeout of a retransmission timer, may retransmit the dropped packet on a different path. In general, the timeout for the retransmission timer is in terms of milliseconds, which may cause huge latency and increase the job completion time.

Typically, in UEC enabled AI-ML network, the source endpoint device transmits packets with a certain entropy value to the target endpoint device. Entropy value of the packets may refer to attributes or fields in a packet header that are utilized to introduce variability in packet routing decisions. For example, the entropy value of the packets may assist in load balancing. Thus, by leveraging the entropy values of the packets, the network may minimize the likelihood of certain paths becoming congested, thereby enhancing data flow efficiency and reducing latency. For a given entropy value, the packets follow the same path in the network.

In many embodiments, a source endpoint device may transmit packets of a traffic flow to a target endpoint device via an intermediate network device, for example a switch. The source endpoint device may determine the entropy value of the packets by using a hash derived from selected fields of the corresponding packet header such as source and destination IP addresses, source and destination ports, a protocol type, or the like. These selected fields may be same within a traffic flow. Thus, the packets belonging to the same traffic flow may have same entropy value (e.g., a first entropy value) and may be forwarded along the same transmission path by the intermediate network device. The transmission path may include one or more transmit and receive ports of the source endpoint device, the target endpoint device, and the intermediate network device.

In a number of embodiments, the intermediate network device may receive the packets associated with the first entropy value from the source endpoint device. Further, the intermediate network device may identify a first port associated with the first entropy value for transmission of the packets associated with the first entropy value. For example, the intermediate network device may identify the first port by performing an Equal-Cost Multi-Path (ECMP) route lookup based on the first entropy value. The intermediate network device may further detect whether the first port is available for transmission or not. In certain embodiments, the first port may be detected as unavailable if a communication link associated with the first port is down. In certain additional embodiments, the first port may be detected as unavailable if the first port or the communication link associated with the first port is experiencing congestion. In various embodiments, the first port may be detected as unavailable if the first port is experiencing port failure.

In a case where the intermediate network device detects that the first port is unavailable for transmission, the intermediate network device may modify at least one packet associated with the first entropy value and transmit the modified packet via a second port of the intermediate network device, for example, to a destination endpoint device of the at least one packet.

In a variety of embodiments, prior to transmitting the modified packet, the intermediate network device may select the second port from a plurality of ports of the intermediate network device such that the second port is different from the first port. In some embodiments, the second port may correspond to a backup port for the first entropy value and can be selected based on the ECMP route lookup. In some more embodiments, the second port may be associated with a second entropy value different from the first entropy value.

In more embodiments, to modify the at least one packet, the intermediate network device may trim a payload from the at least one packet and change a first priority value to a second priority value. The second priority value may be the highest priority value for the second port. Changing the first priority value to the second priority value may ensure that the modified packet gets transmitted without any delay from the second port. Further, after trimming, one or more header fields of the at least one packet may be retained in the modified packet. The retained header fields may include essential information about the corresponding packet, for example, source and destination addresses, a packet sequence number (PSN), error checking information, an opcode field, protocol details, or the like. In yet more embodiments, the destination endpoint, upon receiving the modified packet (e.g., the trimmed packet), may transmit a negative acknowledgment (NACK) to the intermediate network device. The NACK may include a reason code assigned for a trimmed packet type and the first entropy value. The intermediate network device may forward the NACK to the source endpoint device. In still more embodiments, the source endpoint device, upon receiving the NACK with the reason code assigned for the trimmed packet type and the first entropy value, may defer a utilization of the first entropy value for at least one round trip time associated with the first entropy value. In still yet more embodiments, the source endpoint may transmit at least one new packet, having a different entropy value from the first entropy value, of the traffic flow. The at least one new packet may correspond to a retransmitted version of the at least one packet. The intermediate network device may then receive the at least one new packet and forward the at least one new packet using a different port from the unavailable first port.

In additional embodiments, to modify the at least one packet, the intermediate network device may insert a congestion indicator in the at least one packet. For example, the congestion indicator may include an Explicit Congestion Notification (ECN) mark. In yet additional embodiments, the destination endpoint, upon receiving the modified packet (e.g., the at least one packet with the congestion indicator), may transmit an acknowledgment (ACK) to the intermediate network device. The ACK may also include the congestion indicator. The intermediate network device may forward the ACK including the congestion indicator to the source endpoint device. In still additional embodiments, the source endpoint device, upon receiving the ACK including the congestion indicator, may defer or stop the utilization of the first entropy value for the one round trip time to relieve the congestion. Further, the source endpoint may transmit at least one new packet, having a different entropy value from the first entropy value, of the traffic flow. The intermediate network device may then receive the at least one new packet and forward the at least one new packet using a different port from the unavailable first port. Thus, the present disclosure provides a solution whereby the source endpoint device may avoid choosing the first entropy value, experiencing congestion or port failure, within one round trip time (RTT). In other words, the present solution utilizes UEC protocol notification to change the path of the packets within one round trip time (RTT). Thus, the source endpoint may not be required to rely on timeout of retransmit timer, thereby reducing latency and improving job completion time.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams /d/ or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

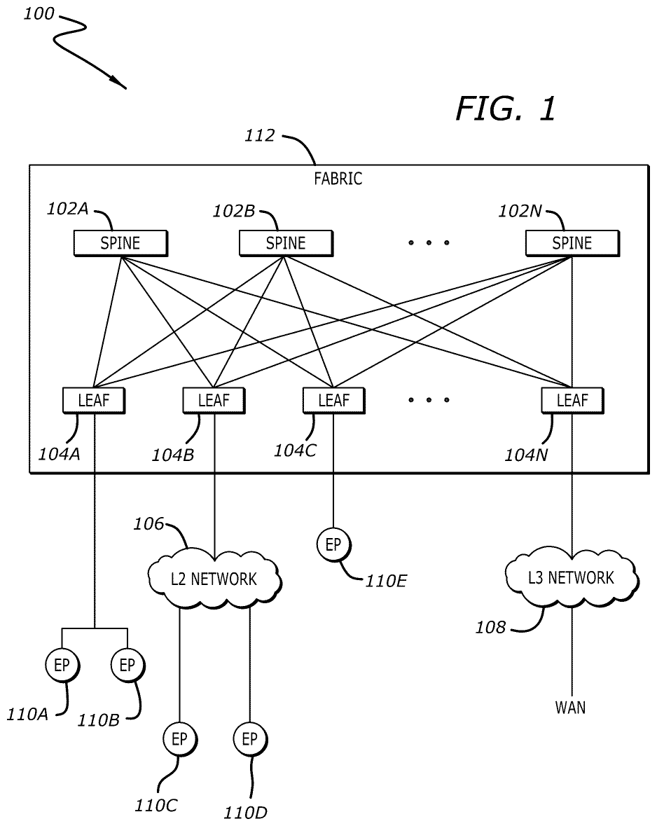

FIG. 1 illustrates a schematic block diagram of an example architecture 100 for a network fabric 112. The network fabric 112 can include spine switches 102A, 102B, . . . 102N (collectively “102”) connected to leaf switches 104A, 104B, 104C . . . 104N (collectively “104”) in the network fabric 112. As those skilled in the art will recognize, networking fabric can refer to a high-speed, high-bandwidth interconnect system that enables multiple devices to communicate with each other efficiently and reliably. It is a network topology that is designed to provide a flexible and scalable infrastructure for data center, cloud environments, and other network elements.

Various embodiments described herein can include a leaf-spine architecture comprising a plurality of spine switches and leaf switches. Spine switches 102 can be L1 switches in the network fabric 112. However, in some cases, the spine switches 102 can also, or otherwise, perform L2 functionalities. Further, the spine switches 102 can support various capabilities, such as, but not limited to, 40 or 10 Gbps Ethernet speeds. To this end, the spine switches 102 can be configured with one or more 40 Gigabit Ethernet ports. In certain embodiments, each port can also be split to support other speeds. For example, a 40 Gigabit Ethernet port can be split into four 10 Gigabit Ethernet ports, although a variety of other combinations are available.

In many embodiments, one or more of the spine switches 102 can be configured to host a proxy function that performs a lookup of the endpoint address identifier to locator mapping in a mapping database on behalf of leaf switches 104 that do not have such mapping. The proxy function can do this by parsing through the packet to the encapsulated tenant packet to get to the destination locator address of the tenant. The spine switches 102 can then perform a lookup of their local mapping database to determine the correct locator address of the packet and forward the packet to the locator address without changing certain fields in the header of the packet.

In various embodiments, when a packet is received at a spine switch 102ᵢ, wherein subscript “i” indicates that this operation may occur at any spine switch 102A to 102N, the spine switch 102ᵢ can first check if the destination locator address is a proxy address. If so, the spine switch 102ᵢ can perform the proxy function as previously mentioned. If not, the spine switch 102ᵢ can look up the locator in its forwarding table and forward the packet accordingly.

In a number of embodiments, one or more spine switches 102 can connect to one or more leaf switches 104 within the network fabric 112. Leaf switches 104 can include access ports (or non-fabric ports) and fabric ports. Fabric ports can provide uplinks to the spine switches 102, while access ports can provide connectivity for devices, hosts, endpoints, VMs, or external networks to the network fabric 112.

In more embodiments, leaf switches 104 can reside at the edge of the network fabric 112, and can thus represent the physical network edge. In some cases, the leaf switches 104 can be top-of-rack (“ToR”) switches configured according to a ToR architecture. In other cases, the leaf switches 104 can be aggregation switches in any particular topology, such as end-of-row (EoR) or middle-of-row (MoR) topologies. The leaf switches 104 can also represent aggregation switches, for example.

In additional embodiments, the leaf switches 104 can be responsible for routing and/or bridging various packets and applying network policies. In some cases, a leaf switch can perform one or more additional functions, such as implementing a mapping cache, sending packets to the proxy function when there is a miss in the cache, encapsulate packets, enforce ingress or egress policies, etc. Moreover, the leaf switches 104 can contain virtual switching functionalities, such as a virtual tunnel endpoint (VTEP) function.

In further embodiments, network connectivity in the network fabric 112 can flow through the leaf switches 104. Here, the leaf switches 104 can provide servers, resources, endpoints, external networks, or VMs access to the network fabric 112, and can connect the leaf switches 104 to each other. In some cases, the leaf switches 104 can connect endpoint groups to the network fabric 112 and/or any external networks. Each endpoint group can connect to the network fabric 112 via one of the leaf switches 104, for example.

Endpoints 110 A-E (collectively “110”, shown as “EP”) can connect to the network fabric 112 via leaf switches 104. For example, endpoints 110A and 110B can connect directly to leaf switch 104A, which can connect endpoints 110A and 110B to the network fabric 112 and/or any other one of the leaf switches 104. Similarly, endpoint 110E can connect directly to leaf switch 104C, which can connect endpoint 110E to the network fabric 112 and/or any other of the leaf switches 104. On the other hand, endpoints 110C and 110D can connect to leaf switch 104B via L2 network 106. Similarly, the wide area network (WAN) can connect to the leaf switches 104N via an L3 network 108.

In certain embodiments, endpoints 110 can include any communication device, such as a computer, a server, a switch, a router, etc. In some cases, the endpoints 110 can include a server, hypervisor, or switch configured with a VTEP functionality which connects an overlay network. The overlay network can host physical devices, such as servers, applications, endpoint groups, virtual segments, virtual workloads, etc. In addition, the endpoints 110 can host virtual workload(s), clusters, and applications or services, which can connect with the network fabric 112 or any other device or network, including an external network. For example, one or more endpoints 110 can host, or connect to, a cluster of load balancers or an endpoint group of various applications.

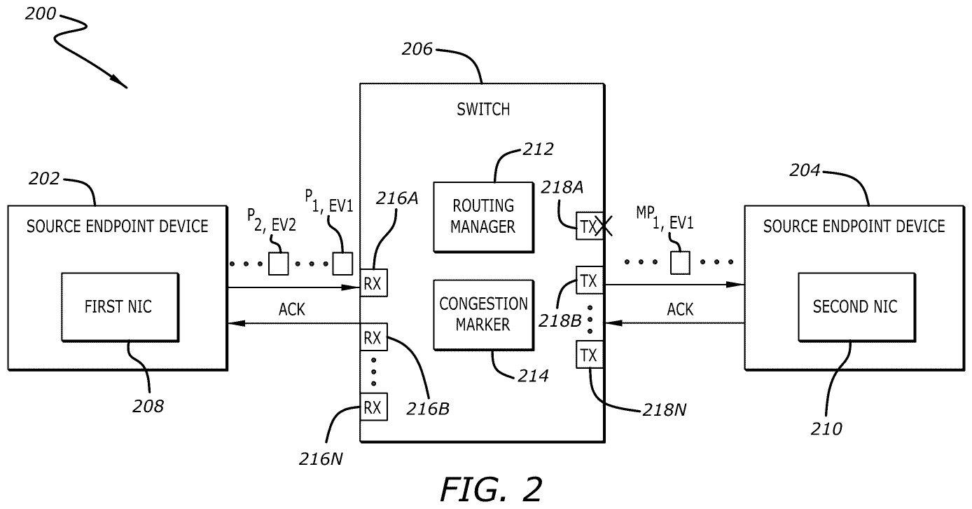

Although a specific embodiment for an architecture 100 is described above with respect to FIG. 1, any of a variety of systems and/or processes may be utilized in accordance with embodiments of the disclosure. For example, the architecture 100 could comprise any variety of endpoints, spine switches, and/or leaf switches. The elements depicted in FIG. 1 may also be interchangeable with other elements of FIGS. 2-10 as required to realize a particularly desired embodiment.

Referring to FIG. 2, an example network system 200 for congestion management between a source endpoint device and a target endpoint device in accordance with various embodiments of the disclosure is shown. The network system 200 can utilize an InfiniBand (IB) fabric, Ethernet-based Remote Direct Memory Access (RDMA) network, Ultra Ethernet Consortium (UEC) enabled networks, Leaf-Spine architecture, cloud network, or the like. The embodiments depicted in FIG. 2 may show a scenario where a source endpoint device 202 is communicatively coupled to a target endpoint device 204 via a switch 206.

In many embodiments, the source endpoint device 202 may be a computing network device that is capable of RDMA (or is a part of UEC-enabled fabric) and configured to initiate an RDMA data transfer process. Examples of the source endpoint device 202 may include a graphics processing unit (GPU), a server, an Internet of Things (IoT) device, a mobile device, or the like. The source endpoint device 202 may include a first network interface controller (NIC) 208. The first NIC 208 may include a gigabit Ethernet adapter or any similar component that may connect the source endpoint device 202 to other devices, for example, the switch 206, over a network.

The first NIC 208 may be configured to segment data into one or more manageable units, for example, one or more packets (hereinafter, referred to as “the packets”). Each packet may include a payload and one or more headers. The payload may include a segmented portion of the original data being transmitted. One or more headers may include essential information about the corresponding packet, for example, source and destination addresses, a packet sequence number (PSN), error-checking information, an opcode field, protocol details, or the like. The source and destination addresses may include a source Internet Protocol (IP) address, a destination IP address, a source port number, and a destination port number. Each packet may also be associated with an entropy value. The entropy value may correspond to a hash value derived from selected fields in a packet header such as source and destination IP addresses, source and destination ports, protocol type, or other fields as per the network implementation. Network devices (such as routers, switches, or the like) may determine the entropy value when the network devices process a packet for routing, using fields from the packet header. The entropy value of a packet is utilized to uniquely identify or distinguish traffic flows in a network. Typically, packets belonging to the same flow follow the same path within the network due to having the same entropy value.

In a variety of embodiments, the first NIC 208 may be configured to transmit one or more packets of a traffic flow to the switch 206 for further routing towards a destination, for example, the target endpoint device 204. In additional embodiments, the first NIC 208 may utilize Equal-Cost Multi-Path (ECMP) routing strategy to ensure that packets belonging to the same traffic flow are forwarded along the same path by the switch 206. ECMP may utilize 5-tuple based hashing mechanism, where the 5-tuple may include source and destination IP addresses, source and destination ports, and protocol information. Thus, ECMP may ensure that all packets of a particular traffic flow are sent over the same path by consistently hashing the same 5-tuple to the same path, thereby avoiding the issue of packet reordering. In an example shown in FIG. 2, the first NIC 208 may transmit a first packet P_{1, EV1} of a first traffic flow to the switch 206 for routing to the target endpoint device 204. The first packet P_{1, EV1} may be associated with a first entropy value, for example, “EV1”.

In more embodiments, the switch 206 may be another network device that includes a plurality of ports, such as one or more receive ports 216A, 216B, . . . , 216N and one or more transmit ports 218A, 218B, . . . , 218N. Hereinafter, the one or more receive ports 216A, 216B, . . . , 216N are collectively referred to as “the receive ports 216” and the one or more transmit ports 218A, 218B, . . . , 218N are collectively referred to as “the transmit ports 218”. The switch 206 may be configured to execute packet routing by receiving the packets from the source endpoint device 202 (e.g., the first NIC 208) via the receive ports 216 and forwarding the packets to corresponding destinations, for example, the target endpoint device 204 (e.g., a second NIC 210) via the transmit ports 218.

In still further embodiments, the switch 206 may employ a packet buffering mechanism (e.g., a send/receive queue pair) to temporarily store incoming packets of a traffic flow, for example, during times of congestion or high network traffic. The switch 206 can further support Quality of Service (QoS) features to prioritize certain types of traffic over others. For example, the switch 206 can associate a priority traffic class (e.g., a high-priority traffic class, a medium-priority traffic class, a low-priority traffic class, etc.) with an incoming packet. The switch 206 may utilize a switching fabric, such as a routing manager 212, to manage the flow of the packets through the plurality of ports. Examples of the switch 206 may include an Ethernet switch, an IB switch, or the like.

In still more embodiments, the routing manager 212 may include suitable logic, circuitry, interface, or program code, executed by the circuitry, that may be configured to employ load balancing techniques to map packets having a particular entropy value to a port associated with the particular entropy value. For example, the routing manager 212 can utilize a hash technique, such as ECMP technique, to determine an entropy value associated with a received packet. Once the entropy value is determined, the routing manager 212 may perform an ECMP route look-up to identify which of the transmit ports 218 is associated with the determined entropy value. In an example, the routing manager 212 may maintain a routing table that stores an association of different entropy values with different transmit ports 218. In one or more embodiments, a single transmit port can be associated with one or more entropy values. Thus, the routing manager 212 may ensure that the received packets are directed towards appropriate transmit ports 218 in a deterministic and collision-minimizing manner.

In still additional embodiments, the routing manager 212 may be further configured to detect whether an identified transmit port (e.g., any of the transmit ports 218) for transmitting a received packet is available or unavailable. A transmit port can become unavailable for transmission due to network congestion, communication link failure, logical connection issues, network bandwidth issues, or the like. The routing manager 212 may detect whether the identified transmit port is available or unavailable by detecting whether the identified transmit port is experiencing congestion or not. To detect whether the identified transmit port is experiencing congestion or not, the routing manager 212 may monitor a send queue associated with the identified transmit port and check if a congestion threshold associated with the send queue is exceeded by a queue depth of the send queue. For example, if the routing manager 212 determines that the queue depth of the packets buffered in a send queue of the transmit port 218N exceeds the congestion threshold of the send queue, the routing manager 212 may detect that the transmit port 218N is experiencing congestion and is unavailable for packet transmission.

In a scenario where the identified transmit port is determined available for transmission, the routing manager 212 may transmit the received packet through the identified transmit port. However, if the identified transmit port is determined unavailable for transmission, the routing manager 212 may provide the received packet to a congestion marker 214 within the switch 206 for congestion signaling.

In an example scenario, upon receiving the first packet P_{1, EV1}, the routing manager 212 may perform an ECMP route look-up for the first entropy value “EV1” and identify that a first transmit port 218A is associated with the first entropy value “EV1”. However, the routing manager 212 may further detect that the first transmit port 218A is unavailable for transmission, for example, due to congestion or due to a communication link associated with the first transmit port 218A being down. In such a scenario where the first transmit port 218A is unavailable for transmission, the routing manager 212 may provide the first packet P_{1, EV1} to the congestion marker 214 for congestion signaling.

In still additional embodiments, the congestion marker 214 may be configured to signal congestion without dropping packets. For example, when the congestion marker 214 receives a packet from the routing manager 212, the congestion marker 214 may modify the packet to signal congestion and provide the modified packet to the routing manager 212 for routing. Modifying the packet may involve marking the packet with a congestion indicator. For example, the congestion indicator may be an Explicit Congestion Notification (ECN) mark. Continuing the above example, the congestion marker 214 may receive the first packet P_{1, EV1} from the routing manager 212, modify the first packet P_{1, EV1} by marking with an ECN bit (e.g., the congestion indicator), and provide the modified first packet MP_{1, EV1} to the routing manager 212.

In many further embodiments, the routing manager 212 may be further configured to select a different transmit port from the transmit ports 218B-218N for transmitting the modified packet. The selected transmit port can be associated with a different entropy value than the entropy value of the modified packet. In more embodiments, the selected transmit port may be designated as a back-up port for the entropy value of the modified packet in the routing table. In such a scenario, the routing manager 212 can perform the ECMP look-up to select the back-up port for the entropy value of the modified packet. In still more embodiments, entropy values may not have any designated back-up ports. In such embodiments, the selected transmit port can be any of the remaining transmit ports 218B-218N that is available for transmission. The routing manager 212 may then forward the modified packet to the target endpoint device 204 via the selected different transmit port. Continuing the above example, the routing manager 212 may select a second transmit port 218B, that is different from the first transmit port 218A and is available, for forwarding the modified packet MP_{1, EV1}. The routing manager 212 may then forward the modified packet MP_{1,} EV1 to the target endpoint device 204 via the second transmit port 218B.

In further embodiments, the target endpoint device 204 may be another RDMA-capable network device that functions as a recipient of the data transmitted by the source endpoint device 202. Examples of the target endpoint device 204 may include a GPU, a server, an IoT device, a mobile device, or the like. The target endpoint device 204 may include the second NIC 210. The second NIC 210 may include a gigabit Ethernet adapter or any similar component that may connect the target endpoint device 204 to other devices, for example, the switch 206, over the network.

In many further embodiments, the second NIC 210 may receive, via the switch 206, one or more packets originally transmitted by the source endpoint device 202 or the modified packets corresponding to the packets originally transmitted by the source endpoint device 202. For each received packet (e.g., modified or original), the second NIC 210 may be configured to examine one or more packet headers to extract required information, for example, source and destination address details, congestion indicator, or the like.

In still yet further embodiments, in response to determining that a received packet is a modified packet and includes a congestion indicator, the second NIC 210 may generate an acknowledgment (ACK) response for the received modified packet. The ACK response may include the congestion indicator information of the received modified packet, such as the ECN information. The ACK response may further include additional information such as a destination address, a source address, a PSN of the received modified packet, or the like. The second NIC 210 may then transmit the ACK response to the switch 206, and the switch 206 may forward the ACK response to the appropriate destination address.

Continuing the above example, the second NIC 210 may receive the modified packet MP_{1, EV1} from the switch 206. Since the modified packet MP_{1, EV1} includes the congestion indicator, the second NIC 210 may generate an ACK response including the congestion indicator. The ACK response may further include additional information such as a destination address of the source endpoint device 202, a source address of the target endpoint device 204, a PSN of the modified packet MP_{1, EV1}, or the like. The second NIC 210 may then transmit the ACK response to the switch 206, and the switch 206 may forward the ACK response to the source endpoint device 202.

In still yet further embodiments, the source endpoint device 202 may receive one or more ACK responses from the switch 206 for transmitted packets. The source endpoint device 202 may further inspect each ACK response for presence of any congestion indicator. In a scenario where an ACK response of a transmitted packet includes the congestion indicator, the source endpoint device 202 may defer the utilization of an entropy value associated with the transmitted packet for at least one round trip time associated with the entropy value. In other words, upon receiving the congestion indicator in the ACK response, the source endpoint device 202 may transmit new packets of that traffic flow with a different entropy value for at least one round trip time.

Continuing the above example, the first NIC 208 may receive the ACK response for the modified packet MP_{1, EV1}. Since the ACK response includes the congestion indicator, the first NIC 208 may transmit a second packet P_{2, EV2} of the same first traffic flow with a second entropy value “EV2” that is different from the first entropy value “EV1” and is also unused. Entropy value of the first traffic flow can be changed by changing any of the 5-tuple values used in previously transmitted packets of the first traffic flow. For example, to change the first entropy value to the unused second entropy value, the first NIC 208 may change the source port number associated with the first traffic flow to an unused source port number for at least one round trip time. Since the second packet P_{2, EV2} does not have the first entropy value “EV1”, the switch 206 may identify a different transmit port (e.g., any of the transmit ports 218) that is associated with the second entropy value “EV2” in the routing table and transmit the second packet P_{2, EV2} to the target endpoint device 204 via the different transmit port. Thus, the use of the first entropy value “EV1” is avoided for at least one round trip time, which may aid in resolving the congestion on the first transmit port 218A. Further, if the communication link associated with the first transmit port 218A was down or experiencing failure, the communication link may become available after the round trip time. Thus, the congestion or link failure situations are mitigated without affecting the throughput of the source endpoint device 202. In several embodiments, after the round trip time is over, the first NIC 208 may start using the first entropy value “EV1” for the first traffic flow.

Though in FIG. 2, the routing manager 212 and the congestion marker 214 are shown as separate entities, the scope of the disclosure is not limited to it. In additional embodiments, functionalities of the routing manager 212 and the congestion marker 214 can be integrated into a single component, for example, a controller without deviating from the scope of the disclosure.

Although a specific embodiment of a network system for congestion management between a source endpoint device and a target endpoint device suitable for carrying out the various steps, processes, methods, and operations described herein is discussed with respect to FIG. 2, any of a variety of systems and/or processes may be utilized in accordance with embodiments of the disclosure. In numerous embodiments, for example, the congestion marker 214 may utilize Weighted Random Early Marking (WREM) to assign a weighted congestion indicator, proportional to the degree of congestion, to modify the packets. Thus, the source endpoint device 202 can accordingly adjust the transmission rate or change the transmission port if the WREM congestion indicator indicated severe congestion. The elements depicted in FIG. 2 may also be interchangeable with other elements of FIGS. 1 and 3-10 as required to realize a particularly desired embodiment.

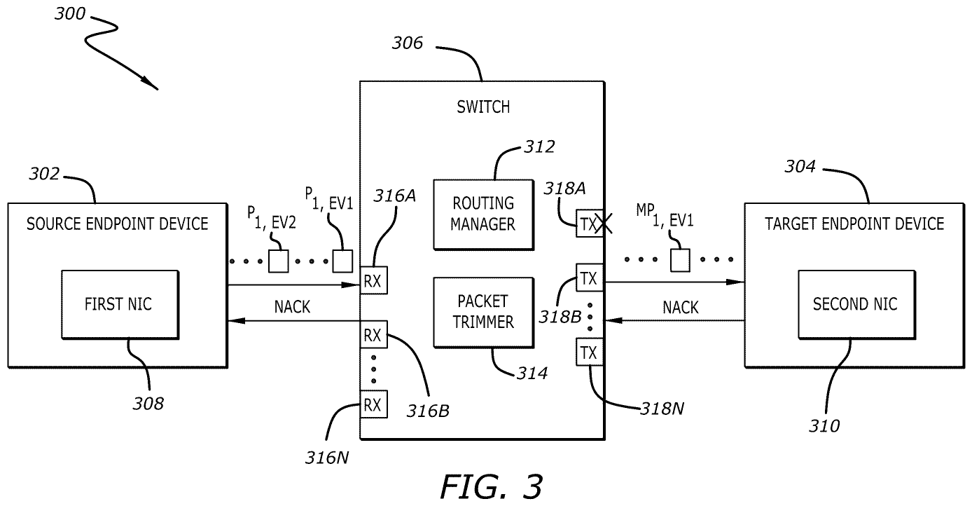

Referring to FIG. 3, an example high-speed network system 300 with improved network resiliency in accordance with various embodiments of the disclosure is shown. The network system 300 can utilize an IB fabric, RDMA network, UEC-enabled networks, Leaf-Spine architecture, cloud network, or the like. The embodiments depicted in FIG. 3 may depict a scenario where a source endpoint device 302 is communicatively coupled to a target endpoint device 304 via a switch 306.

In many embodiments, the source endpoint device 302 may be a computing network device that is capable of RDMA (or is a part of UEC-enabled fabric) and configured to initiate an RDMA data transfer process. Examples of the source endpoint device 302 may include a GPU, a server, an IoT device, a mobile device, or the like. The source endpoint device 302 may include a first NIC 308. The first NIC 308 may include a gigabit Ethernet adapter or any similar component that may connect the source endpoint device 302 to other devices, for example, the switch 306, over a network.

The first NIC 308 may be configured to segment data into one or more manageable units, for example, one or more packets forming a traffic flow. Each packet may include a payload and one or more headers. The payload may include a segmented portion of the original data being transmitted. One or more headers may include essential information about the corresponding packet, for example, source and destination addresses, a PSN, error checking information, an opcode field, protocol details, or the like. The source and destination addresses may include a source IP address, a destination IP address, a source port number, and a destination port number. Each packet may also have an associated entropy value. In a variety of embodiments, the first NIC 308 may be configured to transmit the packets to the switch 306 for further routing towards a destination, for example, the target endpoint device 304. In additional embodiments, the first NIC 308 may utilize ECMP routing strategy to ensure that packets belonging to the same traffic flow are forwarded along the same path. In an example shown in FIG. 3, the first NIC 308 may transmit a first packet P_{1, EV1} to the switch 306 for routing to the target endpoint device 304. The first packet P_{1, EV1} may be associated with a first entropy value, for example, “EV1”.

In more embodiments, the switch 306 may be another network device that includes a plurality of ports, such as one or more receive ports 316A, 316B, . . . , 316N and one or more transmit ports 318A, 318B, . . . , 318N. Hereinafter, the one or more receive ports 316A, 316B, . . . , 316N are collectively referred to as “the receive ports 316” and the one or more transmit ports 318A, 318B, . . . , 318N are collectively referred to as “the transmit ports 318”. The switch 306 may be configured to execute packet routing by receiving the packets from the source endpoint device 302 (e.g., the first NIC 308) via the receive ports 316 and forwarding the packets to corresponding destinations, for example, the target endpoint device 304 (e.g., a second NIC 310) via the transmit ports 318.

In still further embodiments, the switch 306 may utilize a switching fabric, such as a routing manager 312, to manage the flow of the packets through the plurality of ports. In still further embodiments, the switch 306 may further support QoS features to prioritize certain types of traffic over others. For example, the switch 306 can associate a priority traffic class (e.g., a high-priority traffic class, a medium-priority traffic class, a low-priority traffic class, etc.) with an incoming packet. Examples of the switch 306 may include an Ethernet switch, an IB switch, or the like.

In still more embodiments, the routing manager 312 may include suitable logic, circuitry, interface, or program code, executed by the circuitry, that may be configured to employ load balancing techniques to map packets having a particular entropy value to a port associated with the particular entropy value. For example, the routing manager 312 can utilize a hash technique, such as ECMP technique, to determine an entropy value associated with a received packet. Once the entropy value is determined, the routing manager 312 may perform an ECMP route look-up to identify which of the transmit ports 318 is associated with the determined entropy value. In an example, the routing manager 312 may maintain a routing table that stores an association of different entropy values with different transmit ports 318. In one or more embodiments, a single transmit port can be associated with one or more entropy values. Thus, the routing manager 312 may direct the received packets toward the appropriate transmit ports 318 in a deterministic and collision-minimizing manner.

In still additional embodiments, the routing manager 312 may be further configured to detect whether an identified transmit port (e.g., any of the transmit ports 318) is unavailable for transmission. A transmit port can become unavailable for transmission due to communication link failure. In an example, the routing manager 312 may monitor the health of the receive ports 316 and the transmit ports 318. The routing manager 312 may track metrics such as bandwidth utilization, link state (up or down), or the like to determine whether a port is up or down. If the routing manager 312 detects that a port is down or is experiencing link failure, the routing manager 312 may detect that the port is unavailable.

In a scenario where the identified transmit port is determined to be up and running for transmission, the routing manager 312 may transmit the received packet through the identified transmit port. However, if the identified transmit port is determined to be down (e.g., unavailable), the routing manager 312 may provide the received packet to a packet trimmer 314 within the switch for trimming the packet.

In an example scenario, upon receiving the first packet P_{1, EV1}, the routing manager 312 may perform an ECMP route look-up for the first entropy value “EV1” and identify that a first transmit port 318A is associated with the first entropy value “EV1”. However, the routing manager 312 may further detect that the first transmit port 318A is down (e.g., unavailable) for transmission. In such a scenario, where the first transmit port 318A is unavailable for transmission, the routing manager 312 may provide the first packet P_{1, EV1} to the packet trimmer 314.

In still additional embodiments, the packet trimmer 314 may be configured to perform packet trimming. For example, when the packet trimmer 314 receives a packet from the routing manager 312, the packet trimmer 314 may modify the packet by trimming (or removing) a payload from the packet. During modification, the packet trimmer 314 may further change a first priority value of the packet to a second priority value. For example, the packet trimmer 314 may change a priority traffic class of the packet from a medium-priority traffic class to a high-priority traffic class. In the modified packet, the packet trimmer 314 may retain important header fields including essential information about the corresponding packet, for example, source and destination addresses, a PSN, error-checking information, an opcode field, protocol details, or the like After modification, the packet trimmer 314 may provide the modified packet to the routing manager 312. Continuing with the example scenario above, the packet trimmer 314 may receive the first packet P_{1, EV1} from the routing manager 312, modify the first packet P_{1, EV1} by trimming the payload and changing the first priority value to a second priority value, and provide the modified first packet MP_{1, EV1} to the routing manager 312.

In many further embodiments, the routing manager 312 may be further configured to select a different transmit port from the transmit ports 318B-318N for transmitting the modified packet. The selected transmit port can be associated with a different entropy value than the entropy value of the modified packet. In more embodiments, the selected transmit port may be designated as a back-up port for the entropy value of the modified packet in the routing table. In such a scenario, the routing manager 312 can perform the ECMP look-up to select the back-up port for the entropy value of the modified packet. In still more embodiments, entropy values may not have any designated back-up ports. In such embodiments, the selected transmit port can be any of the remaining transmit ports 318B-318N that is available for transmission. The routing manager 312 may then forward the modified packet to the target endpoint device 304 via the selected different transmit port. Continuing the above example, the routing manager 312 may select a second transmit port 318B, that is different from the first transmit port 318A and is up for transmission, for forwarding the modified packet MP_{1, EV1}. The routing manager 312 may then forward the modified packet MP_{1, EV1} to the target endpoint device 304 via the second transmit port 318B.

In many additional embodiments, the target endpoint device 304 may be another RDMA-capable network device that functions as a recipient of the data transmitted by the source endpoint device 302. Examples of the target endpoint device 304 may include a GPU, a server, an IoT device, a mobile device, or the like. The target endpoint device 304 may include the second NIC 310. The second NIC 310 may include a gigabit Ethernet adapter or any similar component that may connect the target endpoint device 304 to other devices, for example, the switch 306, over the network.

In many further embodiments, the second NIC 310 may receive, via the switch 306, one or more packets originally transmitted by the source endpoint device 302 or the modified packets corresponding to the packets originally transmitted by the source endpoint device 302. For each received packet (e.g., modified or original), the second NIC 310 may examine one or more packet headers to extract required information, for example, source and destination address details, or the like.

In still yet additional embodiments, in response to determining that a received packet is a modified trimmed packet, the NIC 310 may generate a negative acknowledgment (NACK) response for the received modified packet. The NACK response may include information such as a destination address, a source address, a PSN of the received modified packet, or the like. In several embodiments, the NACK response may further include a reason code assigned for a trimmed packet type and the first entropy value associated with the modified packet. The reason code may refer to a numeric or symbolic identifier embedded in the header of a packet (or additional metadata) that indicates that the packet was modified by trimming. The second NIC 310 may then transmit the NACK response to the switch 306, and the switch 306 may forward the NACK response to the appropriate destination address.

Continuing the above example, the second NIC 310 may receive the modified packet MP_{1, EV1} from the switch 206. Since the modified packet MP_{1, EV1} is a trimmed packet, the second NIC 310 may generate a NACK response including the reason code assigned for the trimmed packet type. The NACK response may further include additional header information such as a destination address of the source endpoint device 302, a source address of the target endpoint device 304, a PSN of the modified packet MP_{1, EV1}, or the like. The second NIC 310 may transmit the NACK response to the switch 306, and the switch 306 may forward the NACK response to the source endpoint device 302.

In still yet further embodiments, the source endpoint device 302 may receive the NACK response from the switch 306. The source endpoint device 302 may further inspect the NACK for presence of any reason code. In a scenario where a NACK response for a transmitted packet includes the trimmed packet type as reason code, the source endpoint device 302 may infer that the corresponding packet was not successfully delivered to the target endpoint device 304, due to the transmission port being down. The source endpoint device 302 may, therefore, defer the utilization of an entropy value associated with the transmitted packet for at least one round trip time associated with the entropy value. Thus, the source endpoint device 302 may transmit a new packet, e.g., a retransmitted version of the NACKed packet, with a different entropy value for at least one round trip time.

Continuing the above example, the first NIC 308 may receive the NACK response for the modified packet MP_{1, EV1}. In response to receiving the NACK response, the first NIC 308 may retransmit the first packet P_{1, EV2} with a second entropy value “EV2” that is different from the first entropy value “EV1”. Since the retransmitted first packet P_{1, EV2} does not have the first entropy value “EV1”, the switch 306 may identify a different transmit port (e.g., any of the transmit ports 318B, . . . , 318N) that is associated with the second entropy value “EV2” in the routing table and transmit the retransmitted first packet P_{1, EV2} to the target endpoint device 304 via the different transmit port. Thus, the use of the first entropy value “EV1” is avoided for at least one round trip time, during which the communication link associated with the first transmit port 318A may become available. Thus, the link down situation is mitigated without affecting the throughput of the source endpoint device 302. In several embodiments, after the round trip time is over, the first NIC 308 may start using the first entropy value “EV1”.

Although a specific embodiment of a network system for congestion management between a source endpoint device and a target endpoint device suitable for carrying out the various steps, processes, methods, and operations described herein is discussed with respect to FIG. 3, any of a variety of systems and/or processes may be utilized in accordance with embodiments of the disclosure. In further additional embodiments, for example, the first NIC 308 may utilize a PSN based RDMA protocol, for example, the RDMA over Converged Ethernet version 2(RoCEv2 ) protocol, to transmit the packets PSN based RDMA protocols, such as the RoCEv2 protocol, may utilize an adapted protocol stack with IB Layer 4 running on top of a User Datagram Protocol (UDP)/IP to provide reliable, ordered delivery of packets, for example, over Ethernet networks. A PSN based RDMA protocol can further employ a Reliable Connection (RC) mode to ensure strict ordering of packets for RDMA data transfers. The elements depicted in FIG. 3 may also be interchangeable with other elements of FIGS. 1- 2 and 4-10 as required to realize a particularly desired embodiment.

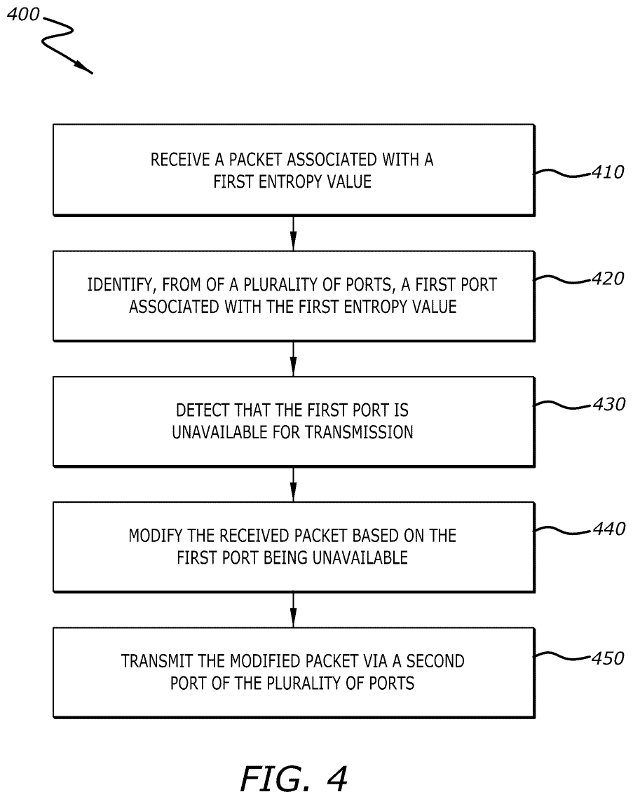

Referring to FIG. 4, a flowchart showing a process 400 for improving network resiliency in a high-speed network in accordance with various embodiments of the disclosure is shown. In many embodiments, the process 400 may receive a packet associated with a first entropy value (block 410). The process 400 may be implemented by an intermediate network device, for example, a switch, that may be connected between a source endpoint and a destination endpoint. In more embodiments, the process 400 may receive the packet from the source endpoint which can be an initiator fabric endpoint (FEP). A network fabric may refer to a structured architecture for interconnecting devices in a network, and FEPs may refer to devices that reside at the edge of a fabric-based architecture, such as a data center fabric. Some of the examples of FEPs can include servers, GPUs, Tensor Processing Units (TPUs), Storage Area Network (SAN) devices, IoT gateways, edge routers, mobile devices, or the like. In various embodiments, the received packet may belong to a traffic flow. In additional embodiments, the received packet may include a payload and may be associated with a first priority value.

In a number of embodiments, the process 400 may identify, from a plurality of ports, a first port associated with the first entropy value (block 420). In an example scenario, the switch may include a plurality of ports operating as receive (ingress) or transmit (egress) ports to maintain the flow of packets. Different ports of the switch can be associated with different entropy values to maintain variability in the distribution or diversity of traffic passing through those ports. The process 400 may, therefore, identify which egress port among all the ports of the switch is associated with serving the traffic flow, and thus associated with the first entropy value, of the received packet. In an example, the process 400 may perform an ECMP route look-up to identify the first port associated with the first entropy value. The identified first port may correspond to a designated transmit port for transmitting packets that are associated with the first entropy value.

In more embodiments, the process 400 may detect that the first port is unavailable for transmission (block 430). In many scenarios, the process 400 may determine that the identified first port is either congested or down, and hence is unavailable for transmission. There can be several reasons for the first port to be down such as faulty or disconnected communication link, damaged connectors, overheating of the switch components, signal interference (such as fiber signal loss due to bending), malfunctioning of the first port or a physical interface card (PIC) of the first port, or other such issues. Similarly, the first port may become congested due to sudden spikes in data flow (such as during backups, software updates, or the like), multiple ingress ports sending traffic to the same egress port, uneven hash distribution in load-balancing mechanisms, the egress port being connected to a slower or lower bandwidth device, or any such issues.

In additional embodiments, the process 400 may modify the received packet based on the first port being unavailable (block 440). For example, the process 400, upon determining that the first port is congested or down, may modify the received packet. In further embodiments, the process 400 may modify the received packet by trimming the payload from the packet and retaining header information such as source/destination addresses, protocol type, PSN, or the like. The process 400 may further change the first priority value of the packet to a second priority value during modification. The second priority value may belong to the higher priority-traffic class than the first priority value. In an example, the process 400 may alter a priority field in the header of the received packet to increase the priority of the modified packet. In still more embodiments, the process 400 may modify the packet to mark the packet with a congestion indicator, for example, an ECN mark. To mark the packet with the congestion indicator, the process 400 can set specific ECN bits, ECN-CE (Congestion Experienced), etc., in the packet header. In an example scenario, the process 400 may modify two bits in a Differentiated Services Field (DS Field) of the packet header, such as ECN-CE bit modified to ‘11’, to mark the packet with the congestion indicator.

In still additional embodiments, the process 400 may transmit the modified packet via a second port of the plurality of ports (block 450). In yet more embodiments, the process 400 may select the second port which is associated with a second entropy value different from the first entropy value. In further embodiments, the second port, selected by the process 400 to transmit the modified packet, may correspond to a backup port for the first entropy value. In such embodiments, the process 400 may utilize ECMP route look-up to select the second port from among the plurality of ports. In many further embodiments, the second port, selected by the process 400 to transmit the modified packet, may correspond to any egress port of the switch that is not associated with the first entropy value and is available.

Although a specific embodiment for improving network resiliency in a high-speed network suitable for carrying out the various steps, processes, methods, and operations described herein is discussed with respect to FIG. 4, any of a variety of systems and/or processes may be utilized in accordance with embodiments of the disclosure. For example, in many further embodiments, the process 400 may prioritize the transmission of the modified packet to ensure that the source endpoint receives a suitable ACK/NACK response for the modified packet before a retransmission trigger times out. The elements depicted in FIG. 4 may also be interchangeable with other elements of FIGS. 1-3 and 5-10 as required to realize a particularly desired embodiment.

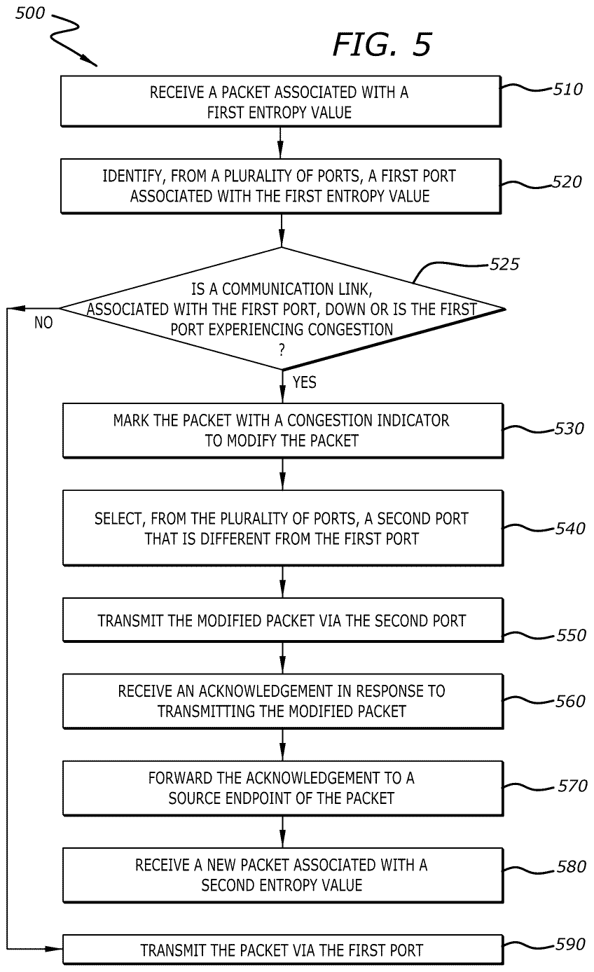

Referring to FIG. 5, a flowchart showing a process 500 for switch-triggered congestion and link failure management using a congestion indicator in accordance with various embodiments of the disclosure is shown. In many embodiments, the process 500 may receive a packet associated with a first entropy value (block 510). The process 500 may be implemented by an intermediate network device, for example, a switch, that may be connected between a source endpoint and a destination endpoint. Some of the examples of the source endpoint and the destination endpoint can include servers, GPUs, TPUs, SAN devices, IoT gateways, edge routers, mobile devices, or the like. In various embodiments, the received packet may belong to a traffic flow.

In a number of embodiments, the process 500 may identify, from a plurality of ports, a first port associated with the first entropy value (block 520). In an example scenario, the switch may include a plurality of ports operating as receive (ingress) ports or transmit (egress) ports to maintain the network traffic flow. Different ports of the switch can be associated with different entropy values to maintain variability in the distribution or diversity of traffic passing through those ports. The process 500 may, therefore, identify which egress port among all the ports of the switch is associated with serving the traffic flow, and thus associated with the first entropy value, of the received packet.

In further embodiments, the process 500 may determine whether a communication link associated with the first port is down or the first port is experiencing congestion (block 525). In a scenario if the communication link associated with the first port is down or if the first port is experiencing congestion, the process 500 may detect that the first port is unavailable for transmission. There can be several reasons for the first port to be down such as faulty or disconnected communication link, damaged connectors, overheating of the switch components, signal interference (such as fiber signal loss due to bending), malfunctioning of the first port or a physical interface card (PIC) of the first port, or other such issues. Similarly, the first port may become congested due to sudden spikes in data flow (such as during backups, software updates, or the like), multiple ingress ports sending traffic to the same egress port, uneven hash distribution in load-balancing mechanisms, the egress port being connected to a slower or lower bandwidth device, or any such issues.

In additional embodiments, if the process 500 determines that the communication link associated with the first port is down or that the first port is experiencing congestion, the process 500 may mark the packet with a congestion indicator to modify the packet (block 530). For example, the process 500 may mark the packet with an ECN mark. The process 500 can set specific ECN bits in the packet header to signal network congestion without dropping the packet.

In further embodiments, the process 500 may select, from the plurality of ports, a second port that is different from the first port (block 540). The process 500, upon determining that the first port associated with the first entropy value is unavailable for transmission either due to congestion or communication link failure, may select the second port for transmitting the modified packet. The second port can be associated with a different entropy value than the first entropy value. In numerous embodiments, the second transmit port may be a designated back-up port for the first entropy value. In such embodiments, the process 500 may again perform the ECMP look-up to select the back-up port for the first entropy value.

In still more embodiments, the process 500 may transmit the modified packet via the second port (block 550). The process 500 may transmit the modified packet via the second port associated with an entropy value different from the first entropy value. The process 500 may transmit the modified packet to the destination endpoint.

In still more embodiments, the process 500 may receive an acknowledgment in response to transmitting the modified packet (block 560). The acknowledgment (such as an ACK response) may be received from the destination endpoint. The ACK response may include the congestion indicator information of the received modified packet, such as the ECN information, for the source endpoint. The ACK response may further include additional information such as a destination address of the source endpoint device, a source address of the target endpoint device, a PSN of the received modified packet, or the like.

In still further embodiments, the process 500 may forward the acknowledgment to a source endpoint of the packet (block 570). The source endpoint may refer to the source device from which the original packet was initially received. In several embodiments, the source endpoint may further inspect the ACK response for the presence of any congestion indicator. If the ACK response includes the congestion indicator, the source endpoint may defer the utilization of the first entropy value for at least one round trip time associated with the first entropy value. Thus, upon receiving the congestion indicator in the ACK response, the source endpoint may transmit new packets of the traffic flow with a different entropy value for at least one round trip time.

In still additional embodiments, the process 500 may receive a new packet associated with a second entropy value (block 580). The process 500 may receive the new packet from the source device, where the new packet may correspond to a subsequent packet of the traffic flow. The new packet may be associated with the second entropy value in response to the determination that the first port associated with the first entropy value is unavailable. In yet more embodiments, the process 500 may transmit the new packet via a port associated with the second entropy value.

In yet more embodiments, if the process 500 determines that the first port is not experiencing congestion and that the communication link of the first port is up for transmission, the process 500 may transmit the packet via the first port (block 590). In other words, if the first port linked or mapped to the first entropy value is available for transmission, the process 500 may transmit the packet via the first port without congestion signaling.

Although a specific embodiment for switch-triggered congestion and link failure management using a congestion indicator suitable for carrying out the various steps, processes, methods, and operations described herein is discussed with respect to FIG. 5, any of a variety of systems and/or processes may be utilized in accordance with embodiments of the disclosure. For example, in several embodiments, the process 500 may utilize Weighted-Cost Multi-Path (WCMP) technique, instead of ECMP, which assigns different weights to different paths based on respective bandwidths, latency, or other metrics. Traffic may be distributed across different paths proportional to the assigned weights. The elements depicted in FIG. 5 may also be interchangeable with other elements of FIGS. 1-4 and 6-10 as required to realize a particularly desired embodiment.

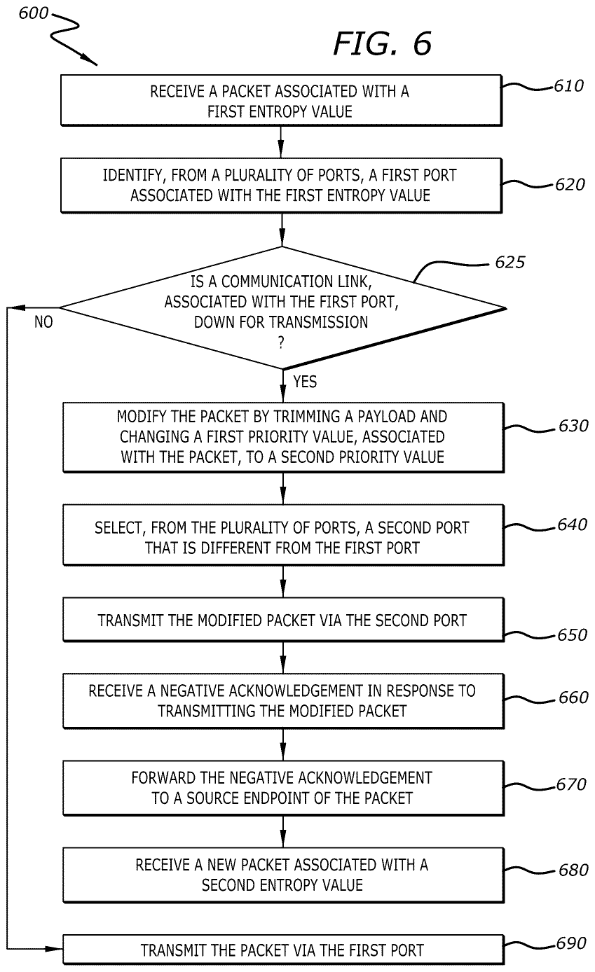

Referring to FIG. 6, a flowchart showing a process 600 for switch-triggered link failure management using a forced NACK response in accordance with various embodiments of the disclosure is shown. In many embodiments, the process 600 may receive a packet associated with a first entropy value (block 610). The process 600 may be implemented by an intermediate network device, for example, a switch, that may be connected between a source endpoint and a destination endpoint. Some of the examples of the source endpoint and the destination endpoint can include servers, GPUs, TPUs, SAN devices, IoT gateways, edge routers, mobile devices, or the like. In various embodiments, the received packet may belong to a traffic flow.

In a number of embodiments, the process 600 may identify, from a plurality of ports, a first port associated with the first entropy value (block 620). In an example scenario, the switch may include a plurality of ports operating as receive (ingress) ports or transmit (egress) ports to maintain the network traffic flow. In a variety of embodiments, the process 600 may utilize ECMP hashing technique to determine a hash value (e.g., the first entropy value) of the packet and may use the determined hash value (or the first entropy value) to perform an ECMP route look-up to identify the first port associated with the first entropy value. The identified first port may correspond to a designated transmit port for transmitting packets that are associated with the first entropy value.

In more embodiments, the process 600 may determine whether a communication link, associated with the first port, is down for transmission (block 625). The communication link, associated with the first port, can be down due to physical issues, logical issues, or external factors. Physical issues affecting the communication link may include broken, damaged, or loose cables (such as Ethernet, fiber optic, etc.), faulty connectors, port or network interface card (NIC) malfunction, power issues in the switch, or the like. Logical issues affecting the communication link may include configuration errors (such as incorrect Virtual Local Area Network (VLAN) configuration, port settings, etc.), mismatched settings for protocols, or the like. External factors may include excessive heat from the environment, electromagnetic interference, or the like.

In additional embodiments, if the communication link, associated with the first port, is down, the process 600 may modify the packet by trimming a payload and changing a first priority value, associated with the packet, to a second priority value (block 630). The second priority value may be the higher than the first priority value. The process 600 may trim the payload of the packet to retain only the important header fields, such as source and destination addresses, a PSN, error-checking information, an opcode field, protocol details, or the like. The process 600 may change the priority field in the header of the packet. The process 600 may change the first priority value to the second priority value to ensure that the modified packet gets transmitted without any delay.

In further embodiments, the process 600 may select, from the plurality of ports, a second port that is different from the first port (block 640). The process 600, upon determining that the first port associated with the first entropy value, is down for transmission, may select a second port for transmitting the modified packet. The second port can be associated with a different entropy value than the first entropy value, and may be currently available for transmission. In still more embodiments, the process 600 may select the second port either randomly or based on port loading. For example, the process 600 may randomly choose the second port, functioning as an alternate egress port, from the available ports for forwarding the packet. Alternatively, the process 600 may evaluate the load on each egress port and select the port that may be least loaded or a port meeting specific criteria for forwarding the modified packet.

In still further embodiments, the process 600 may transmit the modified packet via the second port (block 650). The process 600 may transmit the modified packet to the destination endpoint. In still additional embodiments, the process 600 may receive a negative acknowledgment in response to transmitting the modified packet (block 660). The process 600 may receive the negative acknowledgment (e.g., NACK response) from the destination endpoint in response to the transmitted modified packet.

In yet more embodiments, the process 600 may forward the NACK to the source endpoint of the packet (block 670). The NACK may include information such as a destination address, a source address, a PSN of the received modified packet, or the like. In several embodiments, the NACK may further include a reason code assigned for a trimmed packet type and the first entropy value associated with the packet. The reason code may refer to a numeric or symbolic identifier embedded in the header of a packet (or additional metadata) that explains the packet was modified or trimmed.

In many further embodiments, the process 600 may receive a new packet associated with a second entropy value (block 680). In one or more embodiments, the new packet may correspond to a retransmitted version of the packet that was trimmed. The process 600 may receive the new packet from the source endpoint. In many additional embodiments, the second entropy value may be different from the first entropy value.

However, if the process 600 determines that the communication link, associated with the first port, is not down for transmission, in several embodiments, the process 600 may transmit the packet via the first port (block 690). In other words, if the first port linked or mapped to the first entropy value is available for transmission, the process 600 may transmit the packet via the first port without trimming.

Although a specific embodiment describing switch-triggered link failure management using a forced NACK response suitable for carrying out the various steps, processes, methods, and operations described herein is discussed with respect to FIG. 6, any of a variety of systems and/or processes may be utilized in accordance with embodiments of the disclosure. In numerous embodiments, the process 600 may modify the packet associated with the first entropy value to send back the modified trimmed packet to the source endpoint, instead of forwarding it to the destination endpoint. Thus, the source endpoint may receive the modified packet within half a round trip time. The elements depicted in FIG. 6 may also be interchangeable with other elements of FIGS. 1-5 and 7-10 as required to realize a particularly desired embodiment.

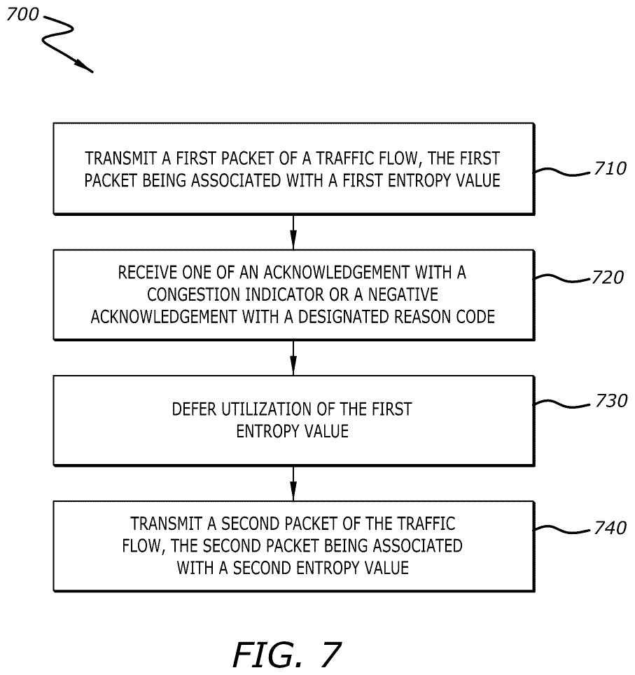

Referring to FIG. 7, a flowchart showing a process 700 for congestion management by a source endpoint device in accordance with various embodiments of the disclosure is shown. In many embodiments, the process 700 may transmit a first packet of a traffic flow, the first packet being associated with a first entropy value (block 710). The process 700 may be implemented by a source endpoint, such as a GPU, a server, an IoT device, a mobile device, or the like.

In a variety of embodiments, the process 700 may receive one of an acknowledgment with a congestion indicator or a negative acknowledgment with a designated reason code (block 720). The received acknowledgment or the negative acknowledgment be received as a response to the transmitted first packet. Further, the received acknowledgment or the negative acknowledgment may also include the first entropy value of the transmitted packet. In an example scenario, a port, associated with the first entropy value, of a switch operating between the source endpoint and a destination endpoint, may be unavailable for transmission. The port can be unavailable due to congestion or communication link failure. Thus, the first packet may be modified by the switch and transmitted to the destination endpoint to seek a faster signaling of congestion or communication link failure for the source endpoint, without packet dropping. The modified first packet may include either a congestion indicator or may be trimmed to remove a payload from the first packet. If the destination endpoint receives the modified packet with the congestion indicator, the destination endpoint may transmit the acknowledgment with the congestion indicator to the source endpoint. However, if the destination endpoint receives the modified packet with trimmed payload, the destination endpoint may transmit the negative acknowledgment with the designated reason code indicating trimmed packet type to the source endpoint.

In number of embodiments, the process 700 may defer utilization of the first entropy value (block 730). The process 700, based on the received acknowledgment with the congestion indicator or the negative acknowledgment with the designated reason code, may determine that the transmission path associated with the first entropy value is experiencing congestion or port failure. Thus, the process 700 may avoid utilization of the first entropy value for at least one round trip time associated with the first entropy value.

In more embodiments, the process 700 may transmit a second packet of the traffic flow, the second packet being associated with a second entropy value (block 740). In several embodiments, the second packet of the traffic flow may either correspond to a next sequenced packet of the traffic flow, or may correspond to a retransmitted version of the first packet. Since the process 700 may determine that the transmission path associated with the first entropy value is experiencing congestion or is down for transmission, the process 700 may force the second packet to be transmitted via a different transmission path associated with the second entropy value.

Although a specific embodiment for congestion management by a source endpoint device suitable for carrying out the various steps, processes, methods, and operations described herein is discussed with respect to FIG. 7, any of a variety of systems and/or processes may be utilized in accordance with embodiments of the disclosure. In several embodiments, the process 700 may be implemented in Software-Defined Networks (SDN). If a particular transmission path may get congested, the process 700 may encapsulate the original packet in a different protocol layer and forward it over an alternative network path. The elements depicted in FIG. 7 may also be interchangeable with other elements of FIGS. 1-6 and 8-10 as required to realize a particularly desired embodiment.

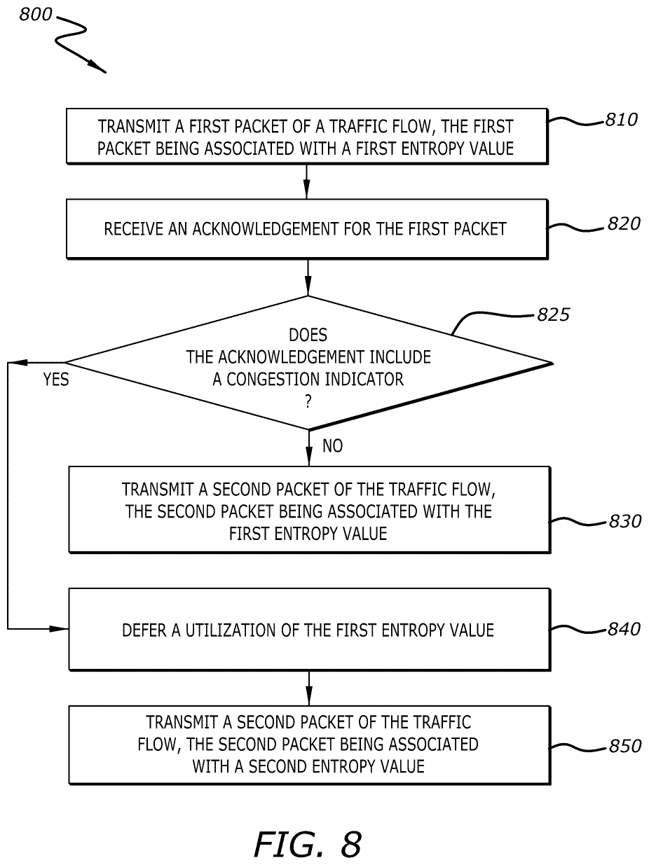

Referring to FIG. 8, a flowchart showing a process 800 for congestion management by a source endpoint device in accordance with various embodiments of the disclosure is shown. In many embodiments, the process 800 may transmit a first packet of a traffic flow, the first packet being associated with a first entropy value (block 810). The process 800 may be implemented by a source endpoint, such as a GPU, a server, an IoT device, a mobile device, or the like. The process 800 may transmit the first packet to a target endpoint, via one or more intermediate network devices, such as a switch.

In a variety of embodiments, the process 800 may receive an acknowledgment for the first packet (block 820). The process 800 may receive the acknowledgment for the delivery of the first packet to the target endpoint the switch. In some embodiments, the acknowledgment may include a congestion signaling. In some more embodiments, the acknowledgment may not include the congestion signaling. The acknowledgment may be received before an expiration of a timeout period associated with the transmitted first packet.

In more embodiments, the process 800 may determine whether the acknowledgment includes a congestion indicator (block 825). The process 800 may receive the acknowledgment corresponding to the first packet associated with the first entropy value. The acknowledgment may include the congestion indicator, such as specific ECN bits set in the header of the acknowledgment, if a first port of the switch associated with the first entropy value is experiencing congestion or link failure. In other words, in spite of the first port experiencing congestion or link failure, the process 800 receives the acknowledgment for the transmitted first packet.

In additional embodiments, if the process 800 determines that the acknowledgment includes the congestion indicator, the process 800 may defer a utilization of the first entropy value (block 840). The process 800 upon receiving the acknowledgment including the congestion indicator may determine that the transmission path associated with the first entropy value is experiencing congestion. Thus, the process 800 may defer utilization of the first entropy value for at least one round trip time.

In further embodiments, the process 800 may transmit a second packet of the traffic flow, the second packet being associated with a second entropy value (block 850). The process 800 may transmit the second packet of the same traffic flow with the second entropy value that is different from the first entropy value, since the process 800 determines that the transmission path associated with the first entropy value is experiencing congestion or communication link failure. Thus, the process 800 is able to transmit subsequent packets of the same traffic flow with a changed entropy value even before the expiration of the timeout period associated with the transmitted first packet, thus, improving network resiliency.

However, in still further embodiments, if the process 800 determines that the acknowledgment does not include the congestion indicator, the process 800 may transmit a second packet of the traffic flow, the second packet being associated with the first entropy value (block 830). Upon receiving the acknowledgment without the congestion indicator, the process 800 may determine that the transmission path associated with the first entropy value is not experiencing congestion. Thus, the process 800 may transmit the second packet of the traffic flow along the same transmission path associated with the first entropy value.

Although a specific embodiment for congestion management by a source endpoint device suitable for carrying out the various steps, processes, methods, and operations described herein is discussed with respect to FIG. 8, any of a variety of systems and/or processes may be utilized in accordance with embodiments of the disclosure. For example, in numerous embodiments, the process 800 may receive a NACK including a sequence number for a particular packet to indicate congestion on the transmission path. The elements depicted in FIG. 8 may also be interchangeable with other elements of FIGS. 1-7 and 9-10 as required to realize a particularly desired embodiment.

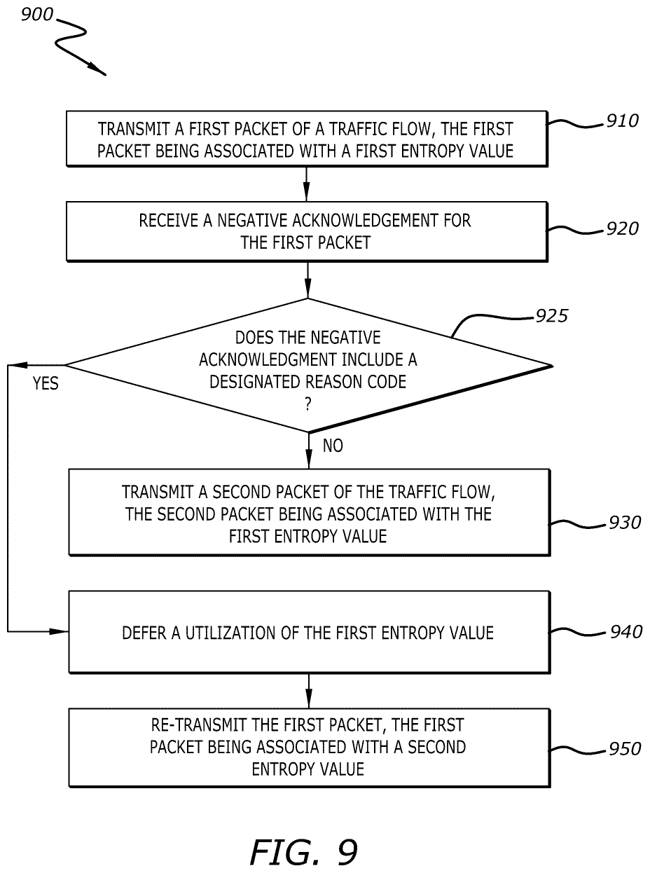

Referring to FIG. 9, a flowchart showing a process 900 for link failure management by a source endpoint device in accordance with various embodiments of the disclosure is shown. In many embodiments, the process 900 may transmit a first packet of a traffic flow, the first packet being associated with a first entropy value (block 910). The process 900 may be implemented by a source endpoint, such as a GPU, a server, an IoT device, a mobile device, or the like.

In number of embodiments, the process 900 may receive a negative acknowledgment for the first packet (block 920). The process 900 may receive the negative acknowledgment in response to a target endpoint receiving a modified trimmed first packet. In the modified trimmed first packet, the payload may have been trimmed.

In a variety of embodiments, the process 900 may determine whether the negative acknowledgment includes a designated reason code (block 925). The reason code may refer to a numeric or symbolic identifier embedded in the header of a packet that explains why the packet was modified or trimmed. For example, reason code ‘10’ can be used in the negative acknowledgment to indicate packet trimming due to a port-down condition. Thus, the process 900 upon receiving the negative acknowledgment with the designated reason code may become aware that an egress port of an intermediate switch of the transmission path, associated with the first entropy value, may be down or experiencing link failure.

In more embodiments, if the negative acknowledgment includes the designated reason code, the process 900 may defer a utilization of the first entropy value (block 940). The process 900, based on the received negative acknowledgment including the designated reason, may determine that the transmission path associated with the first entropy value is down for transmission. Thus, the process 900 may defer utilization of the first entropy value for at least one round trip time.

In further embodiments, the process 900 may re-transmit the first packet, the first packet being associated with a second entropy value (block 950). Since the process 900 may determine that the transmission path associated with the first entropy value is down for transmission, the process 900 may re-transmit the first packet of the traffic flow, via a transmission path associated with the second entropy value. Thus, the process 900 is able to re-transmit the first packet with a changed entropy value even before the expiration of the timeout period associated with the transmitted first packet, thus, improving network resiliency.

However, in additional embodiments, if the process 900 determines that the negative acknowledgment does not include a designated reason code, the process 900 may transmit a second packet of the traffic flow, the second packet being associated with the first entropy value (block 930). Since the negative acknowledgment does not include the designated reason code, the process 900 may determine that the negative acknowledgment may be due to out-of-order packet delivery, packet corruption, or other such reasons. This implies that the transmission path associated with the first entropy value may not be down and can be utilized for the transmission of packets. Thus, the process 900 may transmit the second packet, which is re-transmitted version of the first packet, with the first entropy value.

Although a specific embodiment for congestion management by a source endpoint device suitable for carrying out the various steps, processes, methods, and operations described herein is discussed with respect to FIG. 9, any of a variety of systems and/or processes may be utilized in accordance with embodiments of the disclosure. In numerous embodiments, the negative acknowledgment may include a designated reason code as additional metadata in the packet header. The elements depicted in FIG. 9 may also be interchangeable with other elements of FIGS. 1-8 and 10 as required to realize a particularly desired embodiment.

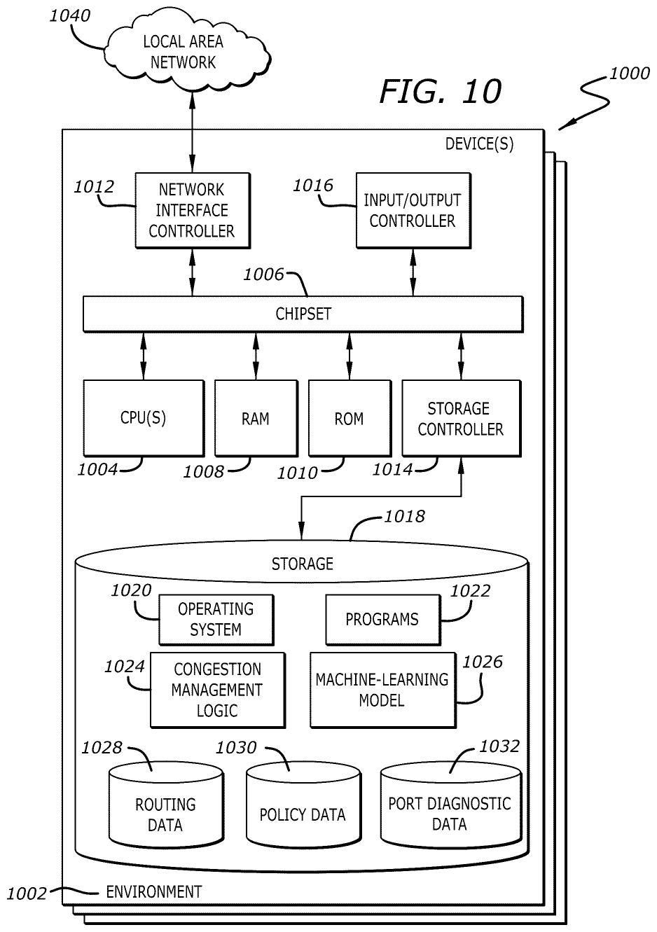

Referring to FIG. 10, a conceptual block diagram for one or more devices 1000 capable of executing components and logic for implementing the functionality and embodiments described above is shown. The embodiment of the conceptual block diagram depicted in FIG. 10 can illustrate a conventional server computer, workstation, desktop computer, laptop, tablet, network appliance, e-reader, smartphone, or other computing device, and can be utilized to execute any of the application and/or logic components presented herein. The device 1000 may, in some examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, programs 1022 (e.g., applications), and data 1028, 1030, 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiment, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as program 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9 . In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10, and can include other components that are not explicitly shown in FIG. 10, or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many embodiments, the device 1000 can include a congestion management logic 1024 that can be configured to perform one or more of the various steps, processes, operations, and/or other methods that are described above. Often, the congestion management logic 1024 can be a set of instructions stored within a non-volatile memory that, when executed by the processor(s) 1004 can carry out these steps, etc. In some embodiments, the congestion management logic 1024 may be a client application that resides on a network-connected device, such as, but not limited to, a server, switch, personal or mobile computing device, an access point (AP). In certain embodiments, the congestion management logic 1024 can improve network resiliency by providing efficient and quick congestion management within the network.

In several embodiments, the congestion management logic 1024 can enable the device 1000 (for example, a switch) to identify congestion within the network or transmission port failure and accordingly transmit a modified packet corresponding to a packet associated with a first entropy value to a destination device. The first entropy value may associate a first packet to a particular transmission path using a first port. The congestion management logic 1024, thus, upon detection of congestion may transmit the modified packet via a second port associated with a second entropy value different from the first entropy value.

In a number of embodiments, the storage 1018 can include routing data 1028. In some embodiments, the routing data 1028 can include mapping information for packets with a particular entropy value to a port associated with the same entropy value. The routing data 1028 may utilize hash technique, such as ECMP, to map various entropy values to different ports. In an example, the routing data 1028 can be stored in the form of an ECMP route table with entropy values mapped to different ports of the device 1000.

In various embodiments, the storage 1018 can include policy data 1030. In several embodiments, the policy data 1030 can comprise information regarding access control lists. Access control lists may delineate a sets of rules that determine what type of traffic is allowed or denied on the network. The set of rules can be based on various criteria such as source or destination IP addresses, port numbers, or communication protocols. In several more embodiments, the policy data 1030 can include QoS policies. For example, QoS policies can be used to prioritize certain types of traffic (e.g., trimmed mirrored packets) over others to ensure that critical applications receive necessary latency requirements. In numerous additional embodiments, the policy data 1030 can further include security policies, authentication, and authorization policies, or the like.

In still more embodiments, the storage 1018 can include port diagnostic data 1032. Port diagnostic data 1032 may include logging and debugging information that enables a network administrator to diagnose various causes of packet drops at the device 1000. In numerous embodiments, the port diagnostic data 1032 may include information regarding status of various receive ports or transmit95 ports, such as whether a particular port is experiencing congestion or is down for transmission due to port failure.

Finally, in many embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to learn network traffic pattern and generate predictions as to when a particular port, associated with a first entropy value, may experience congestion. The ML model 1026 can accordingly predict the utilization of an alternate port, associated with a second entropy value, for routing one or more packets of a traffic flow. In some embodiments, a predictive congestion management logic may be implemented by utilizing the ML model 1026.

The ML model(s) 1026 can be configured to generate inferences to make predictions or draw conclusions from data. An inference can be considered the output of a process of applying a model to new data. This can occur by learning from routing data 1028, policy data 1030, and port diagnostic data 1032 to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a plurality of ports;
a processor;
a memory communicatively coupled to the processor, wherein the memory comprises
a congestion management logic that is configured to:
receive a packet associated with a first entropy value;
identify, from the plurality of ports, a first port associated with the first entropy value;
detect that the first port is unavailable for transmission;
modify the received packet based on the first port being unavailable; and
transmit the modified packet via a second port of the plurality of ports.

2. The network device of claim 1, wherein prior to transmitting the modified packet, the congestion management logic is further configured to select the second port from the plurality of ports, and wherein the second port is different from the first port.

3. The network device of claim 2, wherein the second port is associated with a second entropy value different from the first entropy value.

4. The network device of claim 3, wherein the second port corresponds to a backup port for the first entropy value.

5. The network device of claim 1, wherein to identify the first port, the congestion management logic is further configured to perform an Equal-Cost Multi-Path (ECMP) route lookup based on the first entropy value.

6. The network device of claim 1, wherein detecting that the first port is unavailable comprises detecting that a communication link associated with the first port is down.

7. The network device of claim 1, wherein detecting that the first port is unavailable comprises detecting that the first port is experiencing congestion.

8. The network device of claim 1, wherein the received packet includes a payload and is associated with a first priority value.

9. The network device of claim 8, wherein to modify the packet, the congestion management logic is further configured to:
trim the payload from the packet; and
change the first priority value to a second priority value.

10. The network device of claim 9, wherein the congestion management logic is configured to transmit the modified packet to a destination endpoint of the received packet.

11. The network device of claim 10, wherein the congestion management logic is further configured to:
receive a negative acknowledgment in response to transmitting the modified packet,
wherein the negative acknowledgment comprises a reason code assigned for a trimmed packet type and the first entropy value;
forward the negative acknowledgment to a source endpoint of the packet; and
receive, from the source endpoint, at least one new packet associated with a second entropy value based on the forwarded negative acknowledgment, wherein the second entropy value is different from the first entropy value.

12. The network device of claim 11, wherein the new packet corresponds to a retransmitted version of the packet.

13. The network device of claim 1, wherein to modify the packet, the congestion management logic is further configured to mark the packet with a congestion indicator.

14. The network device of claim 13, wherein the congestion indicator includes an Explicit Congestion Notification (ECN) mark.

15. The network device of claim 13, wherein the congestion management logic is further configured to:
receive an acknowledgment in response to transmitting the modified packet, wherein the acknowledgment comprises the congestion indicator;
forward the acknowledgment to a source endpoint of the packet; and
receive, from the source endpoint, at least one new packet associated with a second entropy value based on the forwarded acknowledgment, wherein the second entropy value is different from the first entropy value.

16. The network device of claim 1, wherein the network device comprises a network switch.

17. A network device, comprising:
a processor;
a memory communicatively coupled to the processor, wherein the memory comprises a congestion management logic that is configured to:
transmit a first packet of a traffic flow, wherein the first packet is associated with a first entropy value;
receive, in response to the transmitted first packet, one of an acknowledgment with a congestion indicator or a negative acknowledgment with a designated reason code; and
transmit a second packet of the traffic flow based on receiving one of the acknowledgment or the negative acknowledgment, wherein the second packet is associated with a second entropy value.

18. The network device of claim 17, wherein the network device corresponds to an initiator endpoint device.

19. The network device of claim 17, wherein the congestion management logic is further configured to defer a utilization of the first entropy value for at least one round trip time associated with the first entropy value.

20. A method for congestion management, the method comprising:
receiving, by a network device, a packet associated with a first entropy value;
identifying, from a plurality of ports of the network device, a first port associated with the first entropy value;
detecting that the first port is unavailable for transmission;
modifying the received packet based on the first port being unavailable; and
transmitting the modified packet via a second port of the plurality of ports.
